(19) United States
(12) Patent Application Publication
(10) Pub. No.: US 2008/0126933 A1
(43) Pub. Date: May 29, 2008

(54) Method and apparatus for multi-mode traversal of lists

(75) Inventors: Sandeep Gupta, Fremont, CA (US); Jeff Lee, Sunnyvale, CA (US); Greg Marriott, Honolulu, HI (US)

Correspondence Address: BEYER LAW GROUP LLP/APPLE INC., P.O. BOX 1687, CUPERTINO, CA, 95015-1687, US

(73) Assignee: Apple Computer, Inc.

(21) Appl. No.: 11/519,298

(22) Filed: Sep. 11, 2006

Related U.S. Application Data
(60) Provisional application No. 60/840,875, filed on Aug. 28, 2006.

(51) Int. Cl. G06F 3/00

(52) U.S. Cl. 715/712

(57) ABSTRACT

Improved methods and systems that assist a user in navigating lists of ordered items are disclosed. According to one embodiment, a character scroll mode enables a user to conveniently and efficiently traverse a list in accordance with one or more significant characters of the items in the list. In one implementation, the list is a list of media items that are arranged in an ordered way. For example, the media items in the list can be arranged alphabetically. Besides the character scroll mode, the user is able to traverse the list in a quantity scroll mode, which may or may not provide acceleration.

### CROSS-REFERENCE TO RELATED APPLICATIONS

This application claims priority benefit to U.S. Provisional Patent Application No. 60/840,875, filed Aug. 28, 2006, and entitled “METHOD AND APPARATUS FOR MULTI-MODE TRAVERSAL OF LISTS,” which is hereby incorporated by reference herein.

This application is also related to: (i) U.S. patent application Ser. No. 10/256,716, filed Sep. 26, 2002, and entitled “METHOD AND SYSTEM FOR LIST SCROLLING,” which is hereby incorporated by reference herein; and (ii) U.S. patent application Ser. No. 10/259,159, filed Sep. 26, 2002, and entitled “METHOD AND APPARATUS FOR USE OF ROTATIONAL USER INPUTS,” which is hereby incorporated by reference herein.

### COPYRIGHT NOTICE

A portion of the disclosure of this patent document contains material that is subject to copyright protection. The copyright owner has no objection to the facsimile reproduction by anyone of the patent document or the patent disclosure as it appears in the U.S. Patent and Trademark Office patent file or records, but otherwise reserves all copyright rights whatsoever.

### BACKGROUND OF THE INVENTION

1. Field of the Invention

The present invention relates generally to user navigation on an electronic device and, more particularly, to user navigation through lists on a handheld electronic device.

2. Description of the Related Art

Today, media playback devices, such as media players or music players, have storage capacity to store large collections of media, namely, music. With such large media collections, in order for a user to select a particular song to be played by the media player, the user typically navigates through a long list of songs. As an example, the user could interact with the media player to display a list of artists that have songs that are stored within the media collection on the media player. The user then scrolls through the list and selects an appropriate song to be played. Unfortunately, however, as the storage capacity of media players increases, the number of songs stored in a media collection on a media player increases. Consequently, the list through which users must navigate in order to select a song can be extensive. One conventional approach to assisting users in traversing large collections of music is to provide acceleration with respect to the user input. For example, U.S. Patent Publication No. 2003/0076301 A1, describes one approach in which a user is able to scroll through lists of songs in an accelerated manner. The degree of acceleration can be based on the speed of a rotational user input. While acceleration is very helpful, in some cases, users can have difficulty or frustration locating the specific song of interest even when acceleration has been applied.

Thus, there remains a need for further approaches to assist a user in navigating through lists of media items.

### SUMMARY OF THE INVENTION

The invention pertains to improved methods and systems that assist a user in navigating lists of ordered items. According to one embodiment of the invention, a character scroll mode enables a user to conveniently and efficiently traverse a list in accordance with one or more significant characters of the items in the list. In one implementation, the list is a list of media items that are arranged in an ordered way. For example, the media items in the list can be arranged alphabetically. Besides the character scroll mode, the user is able to traverse the list in a quantity scroll mode, which may or may not provide acceleration.

The invention can be implemented in numerous ways, including as a method, system, device, apparatus (including graphical User interface), or computer readable medium. Several embodiments of the invention are discussed below.

As a method for assisted traversal of a list of items by a portable electronic device having a user input device and a display, one embodiment of the invention includes at least the acts of: displaying, on the display of the portable electronic device, an initial set of media items from the list that have a current character as a significant character; receiving, via the user input device, a user input pertaining to a traversal action through the list; determining whether to traverse the list in a character mode; and displaying, on the display, a next character when the list is being traversed in the character mode.

As a method for selecting an item in a list of items, another embodiment of the invention includes at least the acts of: receiving a user input having characteristics, and determining whether to utilize a first list traverse mode or a second list traverse mode based on the characteristics of the user input. When operating in the first list traverse mode, the method further includes at least the acts of: determining a next set of the items in the list to be displayed; and displaying the determined next set of items. When operating in the second list traverse mode, the method further includes at least the acts of: determining a next initial character within the list; determining an initial set of items from the list that have the next initial character as their initial significant character; and displaying the determined initial set of items from the list.

As a computer readable medium including at least computer program code for assisting a user of an electronic device in selecting an item in a list of items, one embodiment of the invention includes at least: computer program code for receiving a user input having characteristics; and computer program code for determining whether to utilize a first list traverse mode or a second list traverse mode based on the characteristics of the user input.

As a media playback device, one embodiment of the invention includes at least: a display device; a user input device; at least one memory device capable of storing a plurality of media items and computer program code for displaying and navigating the plurality of media items; and a processing device capable of executing the computer program code for displaying and navigating the plurality of media items. The computer program code for displaying and navigating the plurality of media items includes at least: computer program code for receiving a user input having characteristics; and computer program code for determining whether to utilize a first list traverse mode or a second list traverse mode based on at least one characteristic of the user input.

Other aspects and advantages of the invention will become apparent from the following detailed description, taken in conjunction with the accompanying drawings, illustrating by way of example the principles of the invention.

### BRIEF DESCRIPTION OF THE DRAWINGS

The invention will be readily understood by the following detailed description in conjunction with the accompanying drawings, wherein like reference numerals designate like elements, and in which:

FIG. 1 is a flow diagram of a list traversal process according to one embodiment of the invention.

FIG. 2 is a flow diagram of a list scroll process according to one embodiment of the invention.

FIG. 3 is a flow diagram of a user input process according to one embodiment of the invention.

FIG. 4 illustrates a representative list including a plurality of list items utilized according to one embodiment of the invention.

FIG. 5 is a representative scroll state machine according to one embodiment of the invention.

FIG. 6 is a flow diagram of a character scroll process according to one embodiment of the invention.

FIGS. 7A and 7B illustrate exemplary display screens that can be presented on a display of a portable electronic device according to one embodiment of the invention.

FIG. 8 is a flow diagram of a scroll processing using acceleration according to one embodiment of the invention.

FIG. 9 is a flow diagram of list navigation processing according to one embodiment of the invention.

FIG. 10 is a flow diagram of acceleration amount processing according to one embodiment of the invention.

FIG. 11 is a flow diagram of acceleration amount processing according to another embodiment of the invention.

FIG. 12 is a block diagram of a representative media player suitable for use with the invention.

### DETAILED DESCRIPTION OF THE INVENTION

The invention pertains to improved methods and systems that assist a user in navigating lists of ordered items. According to one embodiment of the invention, a character scroll mode enables a user to conveniently and efficiently traverse a list in accordance with one or more significant characters of the items in the list. In one implementation, the list is a list of media items that are arranged in an ordered way. For example, the media items in the list can be arranged alphabetically. Besides the character scroll mode, the user is able to traverse the list in a quantity scroll mode, which may or may not provide acceleration.

Other aspects and features of the invention will become apparent below. The improved method and systems are suitable for use with electronic devices. The improved methods and systems are particularly well-suited for use with a portable electronic device, such a portable media playback device (e.g., portable media player).

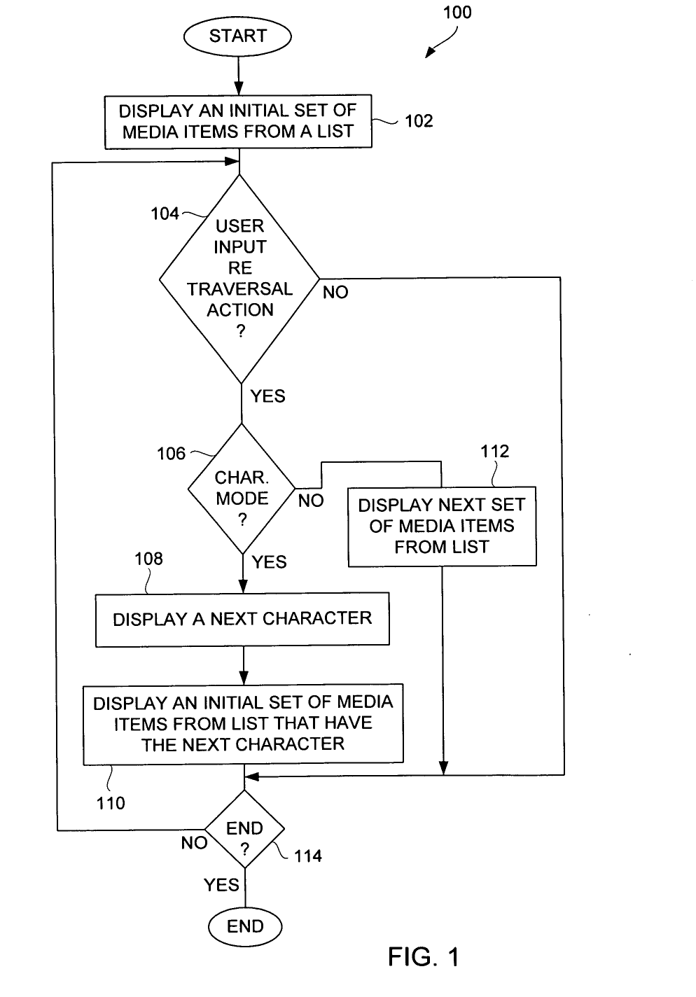

Embodiments of the invention are discussed below with reference to FIGS. 1-12. However, those skilled in the art will readily appreciate that the detailed description given herein with respect to these figures is for explanatory purposes as the invention extends beyond these limited embodiments.

FIG. 1 is a flow diagram of a list traversal process 100 according to one embodiment of the invention. The list traversal process 100 is, for example, performed by a portable electronic device. As one example, the portable electronic device can be a portable media playback device.

The list traversal process 100 is a process by which a user of a portable electronic device is able to traverse a list of media items. Once the list traversal process 100 is invoked, such as through user interaction with the portable electronic device, an initial set of media items can be displayed 102 from a list. The list can include representations of some or all of the media items stored on the portable electronic device. By traversing the list, the user is able to select a particular media item from the list. For example, after a particular media item has been selected, the media item can be played by the portable electronic device.

Next, a decision 104 determines whether a user input with respect to a traversal action for the list has been received. In one embodiment, the portable electronic device includes not only a display device but also a user input device. By interacting with the user input device, the user can provide the user input with respect to the traversal of the list. When the decision 104 determines that a user input with respect to a traversal action for the list has been received, a decision 106 determines whether to operate in a character mode or not. In one embodiment, the determination of whether to operate in a character mode is based on the user input with respect to the traversal action. For example, the user input can indicate that the list is to be traversed in a slow manner or in a fast manner. If the user input indicates that the list should be traversed in a rapid manner, then the character mode would be utilized.

Hence, when the decision 106 determines that the character mode is to be utilized, a next character is displayed 108. As an example, the next character is the next sequential character of an ordered arrangement of items. For example, in an implementation using English, if the current character being displayed pertains to the letter “A” then the next character would be “B”. By displaying 108 the next character, the user of the portable electronic device receives visual feedback as to the particular character being used as the traversal (e.g., scroll) reference point with respect to the list. Further, an initial set of media items from the list that have the next character can be displayed 110. As an example, the initial set here being displayed 110 could pertain to the character “B” which at this point is the next character. In such an example, the initial set of media items would be those of the media items that begin with the character “B”. For example, if the media items are described by artist, album and title, the list would be presented via one of artist, album and title. If, for example, the list were presented as an artist-based list, then the initial set of media items would be a set of the media items that pertains to artists beginning with the character “B”.

Alternatively, when the decision 106 determines that the character mode is not to be utilized, a next set of media items from the list is displayed 112. Here, the next set of media items from the list is not determined with respect to a next character, but is instead determined by selection of a subsequent set of media items from the list based on the relative position within the list. In one example, the next set of media items can be adjacent to the initial set of media items. In another example, the next set of media items could be offset from the initial set of media items. These examples can be considered quantity scroll modes, where a quantity of media items are traversed.

Following the block 110 or the block 112, a decision 114 determines whether the list traversal process 100 should end. When the decision 114 determines that the list traversal process 114 should not end, then the list traversal process 100 returns to repeat the decision 104 and subsequent blocks. On the other hand, when the decision 114 determines that the list traversal process 100 should end, the list traversal process 100 ends. Still further, when the decision 104 determines that the user input with respect to the traversal action has not been received, then the list traversal process 100 performs the decision 114 to determine whether the list traversal process 100 should end at this time.

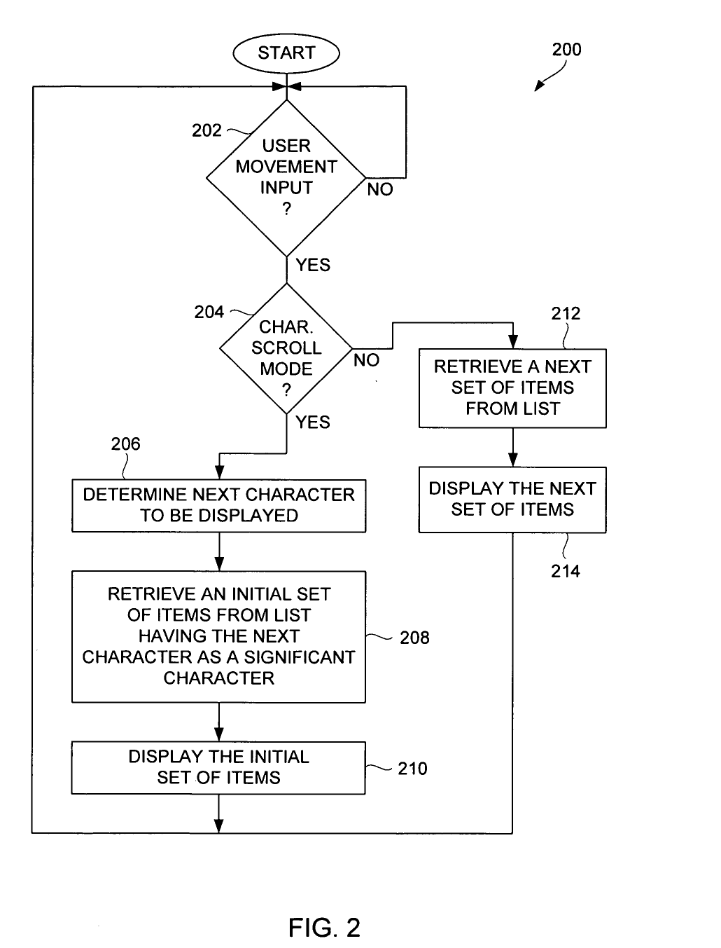

FIG. 2 is a flow diagram of a list scroll process 200 according to one embodiment of the invention. The list scroll process 200 is, for example, performed by a portable electronic device. As one example, the portable electronic device can be a portable media playback device.

This list scroll process 200 begins with a decision 202 that determines whether a user movement input has been received. When the decision 202 determines that a user movement input has not been received, then the list scroll process 200 awaits such an appropriate user movement input. Once the decision 202 determines that an appropriate user movement input has been received, a decision 204 determines whether a character scroll mode is to be utilized. A variety of different techniques can be utilized to determine whether the character scroll mode should be used. In one embodiment, the determination of whether to use the character scroll mode can be automatically determined based on the characteristics of the user movement input. The characteristics can vary with implementation but examples of which include distance, time, speed, pressure, etc. In another embodiment, the determination of whether to use the character scroll mode can be manually initiated by the user of the portable electronic device.

Regardless of the techniques utilized, when the decision 204 determines that the character scroll mode should be utilized, a next character to be displayed is determined 206. Then, an initial set of items from the list having the next character as a significant character are retrieved 208. As an example, punctuation marks or articles (“a”, “an”, “the”, etc.) can be considered as non-significant characters and thus ignored. Next, the initial set of items can be displayed 210. The portable electronic device performing the list scroll process 200 includes a display upon which the initial set of items can be displayed 210. Optionally, in addition to displaying 210 the initial set of items, the next character itself can be displayed. By displaying the next character, the user of the portable electronic device is able to easily acquire visual feedback as to the particular character that is currently of interest while in the character scroll mode. Hence, in the character scroll mode, the user can scan through the available significant characters to assist the user in locating a desired item within the list.

Alternatively, when the decision 204 determines that the character scroll mode is not to be utilized, a next sequential set of items is retrieved 212 from the list. Here, in one embodiment, the list scroll process 200 can be considered to be in a quantity scroll mode when retrieving 212 the next sequential set of items. The next sequential set of items is then displayed 214. The next sequential set of items need not be adjacent to an earlier displayed set of items. Instead, the next sequential set of items is a chosen set of adjacent items provided in the list that are subsequent to an earlier (prior) sequential set of items given the direction of the user movement.

Following the block 210 or the block 214, the list scroll process 200 returns to repeat the decision 202 and subsequent blocks so that subsequent user movement inputs can be processed.

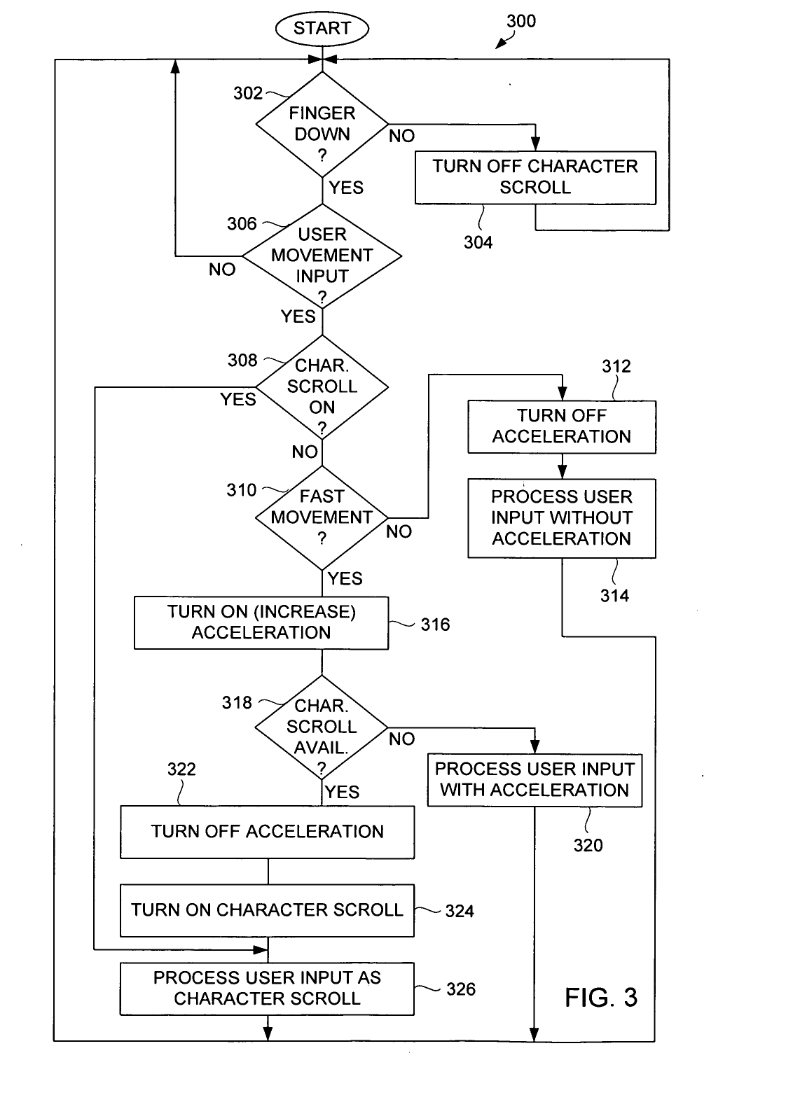

FIG. 3 is a flow diagram of a user input process 300 according to one embodiment of the invention. The user input process 300 is, for example, performed by a portable electronic device having a user input device as well as a display.

The user input process 300 includes a decision 302 that determines whether a finger is engaging the user input device. For example, the user input device can be a touch surface, and the decision 302 can determine whether the user's finger is in contact with or “down” with respect to the user input device. When the decision 302 determines that the user's finger is not engaged with the user input device, character scroll mode is turned off 304. Following the block 304, the user input process 300 returns to repeat the decision 302.

On the other hand, when the decision 302 determines that the user's finger is engaged the user input device, a decision 306 determines whether a user movement input has been received. In this embodiment, it is assumed that a user input movement with respect to the user input device is needed in order to be considered a user input to be further processed. As an example, a user movement can pertain to a finger moving (e.g., sliding) across the touch surface associated with the user input device. This movement with respect to the touch surface can be linear, angular or rotational. When the decision 306 determines that user movement input has not been received, then the user input process 300 returns to repeat the decision 302.

Alternatively, when the decision 306 determines that a user movement input has been received, a decision 308 determines whether the character scroll mode is on. When the decision 308 determines that the character scroll mode is off, a decision 310 determines whether the user movement input is deemed a fast movement. When the decision 310 determines that the user movement input is not deemed a fast movement (e.g., deemed a slow movement), then an acceleration mode is turned off 312. It may be that the acceleration mode is not on at this time; nevertheless, if the acceleration is on at this point, the acceleration is turned off 312. Next, the user input is processed 314 without any application of acceleration (e.g., quantity scroll mode without acceleration).

On the other hand, when the decision 310 determines that the user movement input is deemed a fast movement, acceleration is turned on 316. In one embodiment, acceleration can be provided in a plurality of different levels, with each level offering different levels of acceleration. Hence, at block 316, in one embodiment, if acceleration is already turned on, the user input process 300 can increase the level of acceleration being provided. Next, a decision 318 determines whether character scrolling is available. Here, in one embodiment, character scrolling is only available with respect to certain characters. In other words, for certain unauthorized characters, character scrolling is not available. For example, character scrolling may not be available for certain languages. In any case, when the decision 318 determines that character scrolling is deemed unavailable, the user input is processed 320 with application of acceleration (e.g., quantity scroll with acceleration).

Alternatively, when the decision 318 determines that character scrolling is available, acceleration is turned off 322. Further, the character scroll mode is turned on 324. Then, the user input is processed 326 as a character scroll. With character scrolling, the user input allows the user to scroll through characters, typically, leading significant characters, to locate the character of interest. Once the user reaches the particular character of interest, the user can then locate an item in a list having the particular character as a leading significant character.

Following the blocks 314, 320 or 326, the user input, namely, a user movement input, has been suitably processed and processing of the user input process 300 returns to repeat the decision 302 and subsequent blocks so that additional user inputs can be similarly processed.

As noted above with respect to FIG. 3, a user input can be processed so as to scroll a list of items in one of three ways. In the first way, the user input is processed so as to scroll through the list items in a conventional manner using an individual (or page) item scroll. In a second example, the scrolling through the list can utilize acceleration so that the next list of items being displayed is not adjacent to those previously displayed. The third example is that the list can be scrolled in a character scroll manner such that leading significant characters are utilized to scroll through the list in a rapid manner.

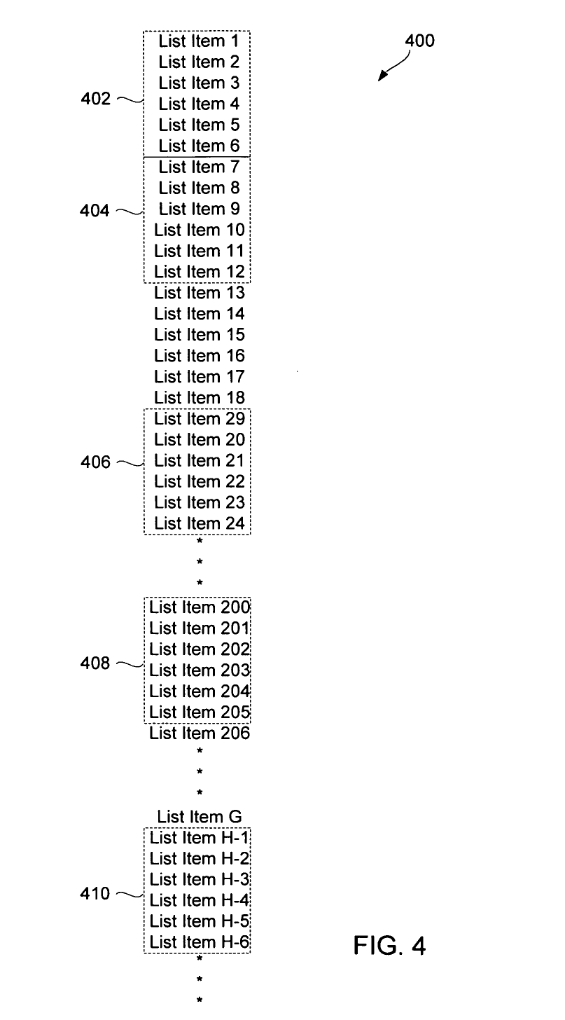

FIG. 4 illustrates a representative list 400 including a plurality of list items utilized according to one embodiment of the invention. The list 400 being displayed in FIG. 4 represents an upper portion of the list 400. The list 400 illustrates an initial set 402 of list items. The initial set 402 of list items can be initially displayed. Then, the user can seek to traverse or scroll the list 400. With character scrolling off and acceleration off, the user can interact with a user input device to provide a user input to cause a second set 404 of list items to be displayed. The second set 404 of list items can result from a user input (e.g., user movement) requesting to scroll down through five (5) list items, individually or as a block. Then, the user can interact with the user input device with acceleration turned on to request that a subsequent set 406 of list items further down the list be displayed. Another subsequent set 408 can later be displayed with use of acceleration. Here, it should be noted that the other subsequent set 408 is beginning with list item 200 indicating that a large number of list items between list item 24 and list item 200 have been skipped through use of a greater degree of acceleration than was used to produce the first subsequent set 406. Thereafter, in the example shown in FIG. 4, the character scroll mode is activated at the character “H” and thus the list items at the set 410 are a grouping of the first set of list items having the significant (leading) character “H”. In this embodiment, the character scroll mode is activated after a certain level of acceleration has been achieved. When the character scroll mode is entered, the selected character is utilized to determine the next appropriate set of items to be displayed.

The various scrolling modes can also be depicted as a state machine having states representing the different modes as well as different acceleration levels or different rates of acceleration when acceleration is used. The particulars of such a state machine will vary widely with implementation.

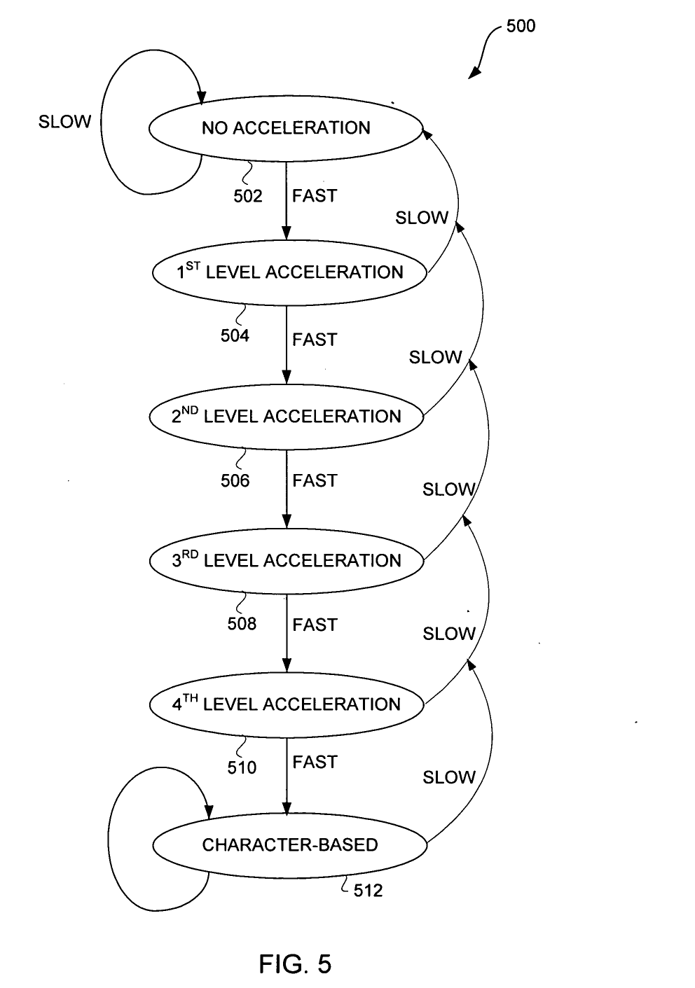

FIG. 5 is a representative scroll state machine 500 according to one embodiment of the invention. The scroll state machine 500 has a standard scroll state, four states of accelerated scroll, and a character scroll state. A first state 502 is the standard scroll state which offers no acceleration. Here, a list is scrolled in direct relation to the user input. From the first state 502, when the speed of a next user input is slow, the scroll state machine 500 remains at the first state 502. Alternatively, when the speed of the user input is fast, the scroll state machine 500 transitions from a first state 502 to a second state 504. The second state 504 provides a first level of acceleration, such as 2× acceleration meaning that the resulting rate of scrolling would be twice that of the first state. When the scroll state machine 500 is at the second state 504, when the speed of a next user input is slow, the scroll state machine 500 transitions back to the first state 502. Alternatively, when the speed of the next user input is fast, the scroll state machine 500 transitions from the second state 504 to a third state 506. The third state 506 provides a second level of acceleration, such as 4× acceleration meaning that the rate of scrolling would be four times that of the first state 502 or twice that of the second state 504. At the third state 506, when the speed of the next user input is slow, the scroll state machine 500 transitions from the third state 506 to the first state 502. Alternatively, when the speed of the next user input is fast, the acceleration state machine 500 transitions from the third state 506 to a fourth state 508. At the fourth state 508, a third level of acceleration is provided, such as 8× acceleration meaning that the acceleration rate of scrolling is eight times that of the first state 502, four times that of the second state 504, or twice that of the third state 506. At the fourth state 508, when the speed of the next user input is slow, the scroll state machine 500 transitions from the fourth state 508 to the first state 502. Alternatively, when the speed of the next user input is fast, the scroll state machine 500 transitions from the fourth state 508 to a fifth state 510. At the fifth state 510, a fourth level of acceleration is provided, such as 16× acceleration meaning that the acceleration rate of scrolling is sixteen times that of the first state 502, eight times that of the second state 504, four times that of the third state 506, or twice that of the fourth state 508. At the fifth state 510, when the speed of the next user input is slow, the scroll state machine 500 transitions from the fifth state 508 to the first state 502.

Alternatively, when the speed of the next user input is fast, the scroll state machine 500 transitions from the fifth state 510 to a sixth state 512. At the sixth state 512, a character-based scrolling is provided. In this embodiment, there is no acceleration as is provided in the second state 504, the third state 506, the fourth state 508 or the fifth state 510. When in the sixth state, the user input is used to perform the character-based scrolling. The character-based scrolling can be performed at a speed in relation to the speed of the user input. The scroll state machine 500 remains in the sixth state 512 until the character-based scrolling is to end. When the character-based scrolling is to end, the scroll state machine 500 transitions from the sixth state 512 to the first state 502. As an example, as noted in blocks 302 and 304 of FIG. 3, when the finger providing user movement is removed from a touch-sensitive surface, character-based scrolling can automatically end.

The user input being utilized to scroll a list can be provided with respect to a user input device. The nature of the user input and the user input device can vary with implementation. In one embodiment, the user input device is a touch-sensitive device and the user input is a touch or movement with respect to the touch-sensitive device. In one implementation, the touch-sensitive device is rectangular and facilitates linear user interaction. In another implementation, the touch-sensitive device is circular and facilitates rotational user interaction.

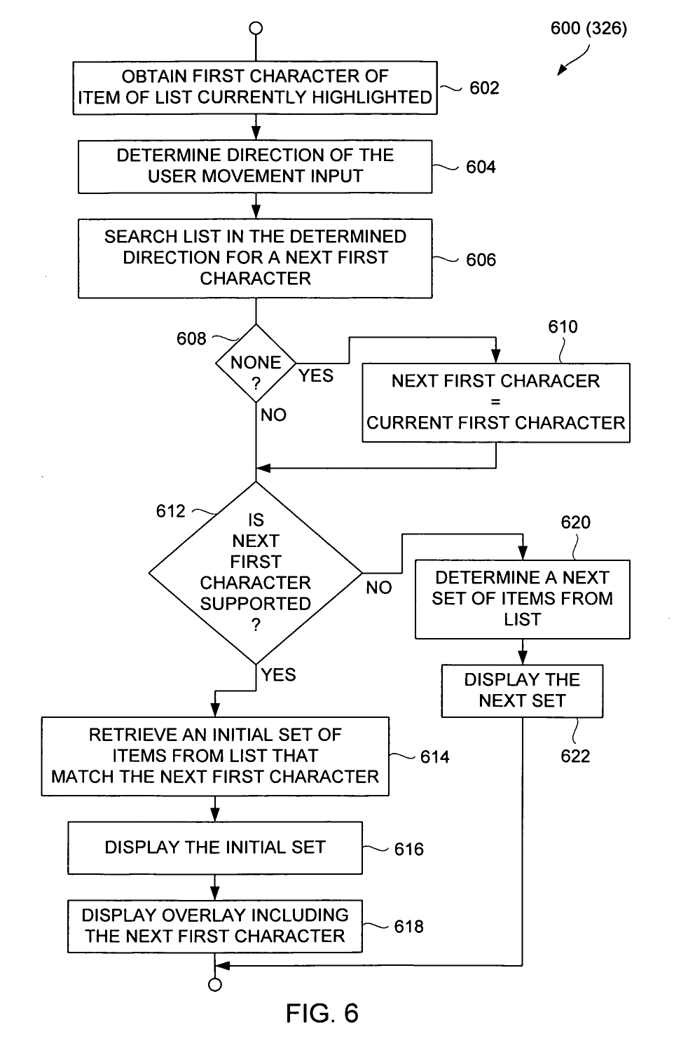

FIG. 6 is a flow diagram of a character scroll process 600 according to one embodiment of the invention. The character scroll process 600 is, for example, suitable for use as processing performed by block 326 illustrated in FIG. 3.

The character scroll process 600 initially obtains 602 a first character of an item of the list that is currently highlighted. The highlighted item of the list is one of the items being displayed on the display of the portable electronic device. The highlighting, which serves to distinguishably display an item, can be achieved in a variety of different ways, including by way of any of color, animation, text/character, etc. After the first character is obtained 602, the direction of the user movement input is determined 604. As an example, the direction of the user movement input can be determined 604 to be upward or downward with respect to the list.

Next, the list is searched 606 in the determined direction for a next first character. For example, if the first character associated with the item of the list currently highlighted is “A” and the determined direction is downward, then the next first character would be “B”. Following the block 606, a decision 608 determines whether there is no next first character. In such case, the next first character is assigned 610 to be the current first character. In other words, if there is no next first character, the current first character continues to be utilized.

Following the block 610 or following the decision 608 when there is a next first character, a decision 612 determines whether the next first character is supported. Here, certain characters may not be supported by the character scroll process 600. As an example, the character scroll mode may be unavailable to certain characters, individually or complete character sets of a language. For instance, given the complexity of Chinese, Japanese and Korean characters, these character sets may not be supported. However, alternatively, some non-English character could be mapped to an English equivalent so that the character is able to be supported. For example, “Ë” can be mapped to “E”. As another example, “æ” can be mapped to “ae”. Hence, a decision 612 determines whether the next first character is supported. When the decision 612 determines that the next first character is supported, an initial set of items from the list that match the next first character are retrieved 614. The initial set is then displayed 616. Additionally, an overlay including the next first character can be displayed 618. In one embodiment, the overlay including the next first character is displayed 618 over a portion of the initial set which is also displayed 616. In other words, the overlay can be displayed concurrently with the initial set. Still further, in one embodiment, the overlay can be partially translucent so that even though the overlay is placed over a portion of the initial set also being displayed, the portion of the initial set that is under the overlay can still be partially viewed given that the overlay is partially translucent.

Alternatively, when the decision 612 determines that the next first character is not supported, a next set of elements from the list is determined 620. Then, the next set is displayed 622. In this case, character-based scrolling is not used. Instead, the next set of items being determined 620 is either an adjacent set of items or some other set in the direction of the user movement input, which could be arrived at through use of acceleration. Following the block 618 and the block 622, the character scroll process 600 is completed.

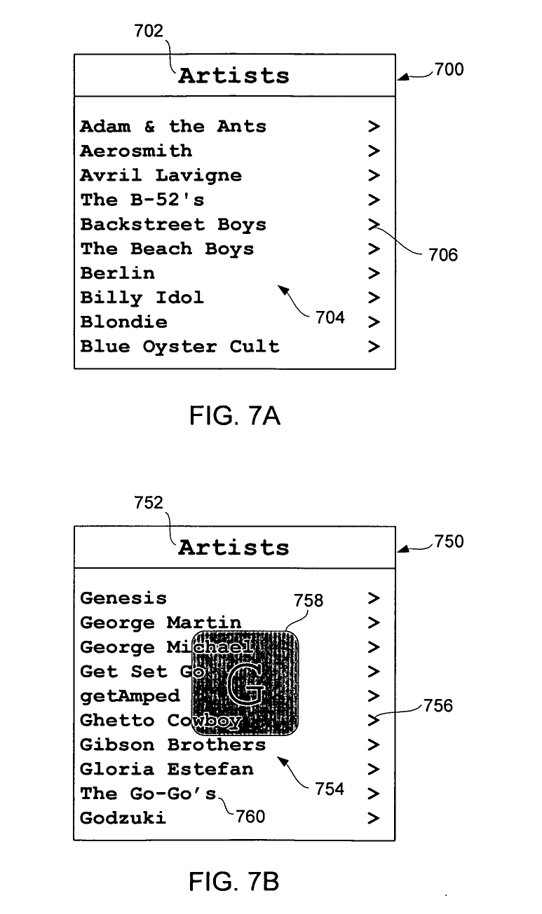

FIGS. 7A and 7B illustrate exemplary display screens that can be presented on a display of a portable electronic device according to one embodiment of the invention.

FIG. 7A is an exemplary illustration of a display screen 700 in which a particular list is being displayed. In FIG. 7A, the display screen 700 includes a screen title 702 labeled “Artist”. Here, the display screen pertains to artist and includes a list 704 of artists. Typically, the list 704 of artists would be those artists that have media items (e.g., songs) that are stored on the portable electronic device. Note that the artist being displayed within the list 704 are ordered in an alphabetical order. The display screen 700 can also include an indicator 706 that informs the user that upon selection of one of the artists within the list 704, a subsequent display screen will be displayed pertaining to that selected item. For example, selection of one of the artists in the list 704 can cause a display screen having a list of media items of the selected artist.

FIG. 7B is an exemplary illustration of a display screen 750 in which a character-based scroll mode is being utilized according to one embodiment of the invention. The display screen 750 includes a title region 752 that indicates that a list 754 being displayed in the display screen 750 pertains to artists. The list 754 is a list of certain artists that have at least one media item (e.g., song) stored on the portable electronic device. In this case, the artists being displayed within the list 754 are arranged or ordered in an alphabetical order. These artists all begin with the initial significant character “G”. An indicator 756 can indicate that upon selection of one of the artists within the list 754 causes a subsequent display screen to be presented. For example, selection of one of the artists in the list 754 can cause a display screen having a list of media items of the selected artist. In addition, to display the set of items within the list 754, an overlay 758 can be displayed as illustrated in FIG. 7B. The overlay 758 includes the character “G” so as to clearly inform the user of the portable electronic device that their user input action has caused the portable electronic device to scroll through the list 754 so as to present an initial portion of those artists within the list 754 that begin with the significant leading character of “G”. It should be noted that the item 760 within the list 754 does not have the leading character “G”. However, since the articles are typically not significant, the leading articles of “the” and “an” and “a” can be ignored when listing or ordering the items within the list 754. Hence, with the character of interest being “G”, all of the artists being displayed within the display screen 750 begin with the character “G” or at least have the initial significant character being a “G”.

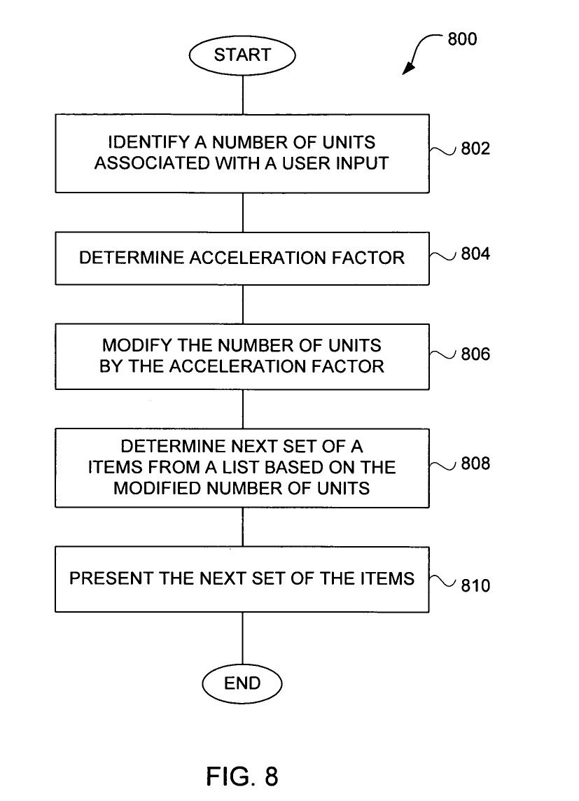

FIG. 8 is a flow diagram of a scroll processing 800 using acceleration according to one embodiment of the invention. The scroll processing 800 is, for example, suitable for use as processing performed by block 320 illustrated in FIG. 3. The scroll processing 800 assists a user in scrolling through a list. The scroll processing 800 initially identifies 802 a number of units associated with a user input. In one implementation, the user input is a rotational user input. The number of units is an indication of an amount of movement a user has invoked with respect to the input device.

Next, an acceleration factor is determined 804. The acceleration factor is an indication of the degree of acceleration to be utilized with the scroll processing 800. After the acceleration factor is determined 804, the number of units that are associated with the user input is modified 806 by the acceleration factor. In one embodiment, the number of units is modified by multiplication with the acceleration factor. In various other embodiments, the number of units can be modified in various other ways.

After the number of units has been modified 806, a next set of items from the list that is being scrolled through can be determined 808 based on the modified number of units. Once the next set of items has been determined 808, the next set of items can be presented 810. Typically, the next set of items can be presented 810 to the user by displaying the next set of items on a display device. After the next portion of the data set has been presented 810, the scroll processing 800 is complete and ends.

Here, the greater the user input in terms of distance traversed, time, speed, etc., the greater degree of scrolling that can be provided in response to the user input. The more acceleration being provided, the further down a list the next set of items becomes.

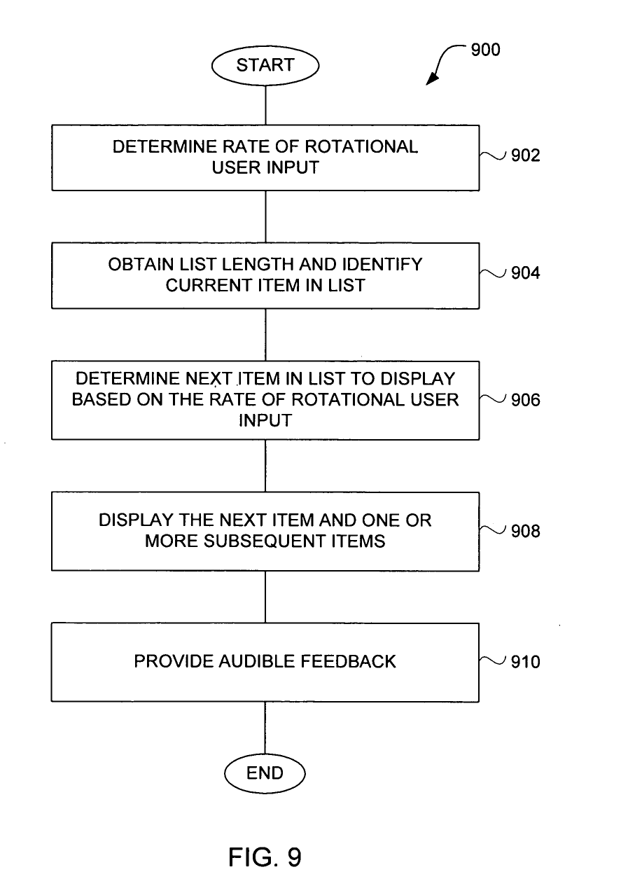

FIG. 9 is a flow diagram of list navigation processing 900 according to one embodiment of the invention. The list navigation processing 900 initially determines 902 a rate of rotational user input (e.g., dial turn or user movement). The rotational user input is provided through user interaction with a rotational input device. A list length is then obtained 904 and a current item in the list is identified. Typically, the current item is the item in the list that is being displayed. In one embodiment, the current item is highlighted such that it is distinctively displayed from other items of the list that are simultaneously displayed.

A next item in the list to be displayed is then determined 906 based on the rotational user input. The determination 906 of the next item in the list can also be dependent on the list length and the current item in the list. For example, the greater the rate of the rotational user input, the further apart the next item is from the current item in the list. The rate of the rotational user input and the length of the list can affect whether acceleration (e.g., acceleration factor) is provided for navigating the list. Thereafter, the list navigation processing 900 displays 908 a next item and one or more subsequent (or neighboring) items thereto. For example, the next item and the one or more subsequent items can be displayed 908 by a display screen produced by a display device. Additionally, the list navigation processing 900 can provide 910 an audio feedback. The audio feedback provides an audible sound that indicates feedback to the user as to the rate at which the items in the list are being traversed. The audible feedback can thus also be proportional to the rate of rotational user input. Such audio feedback can be similarly provided with any of the other embodiments discussed herein which receive user input.

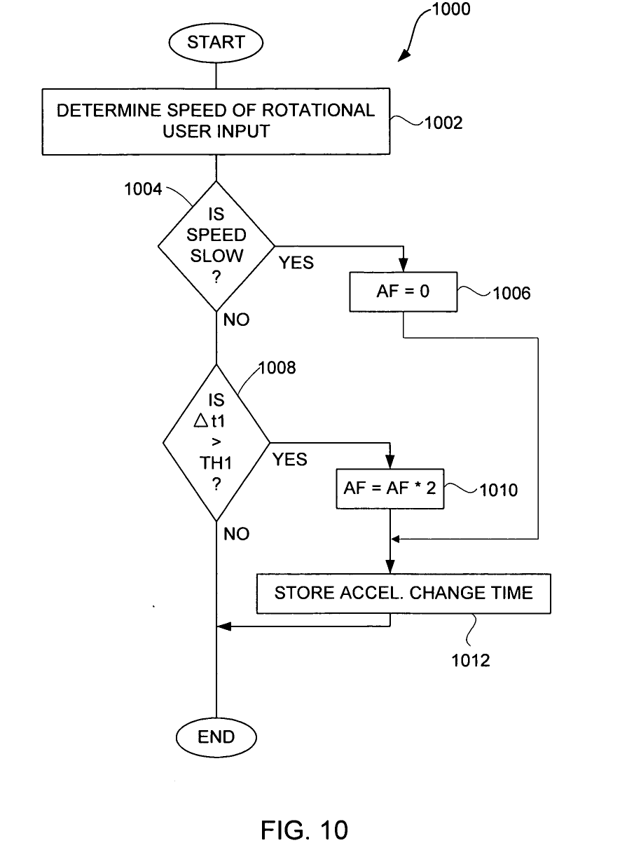

FIG. 10 is a flow diagram of acceleration amount processing 1000 according to one embodiment of the invention. The acceleration amount processing 1000 is, for example, processing that can be performed to determine an acceleration factor. In one embodiment, the acceleration amount processing 1000 is, for example, suitable for use as the operation 804 illustrated in FIG. 8. In another embodiment, the acceleration amount processing 1000 is, for example, suitable for use as a sub-operation for the operation 906 illustrated in FIG. 9.

The acceleration amount processing 1000 initially determines 1002 a speed of a rotational user input. As previously noted with respect to FIGS. 8 and 9, the rotational user input can be provided by a rotational input device that is interacted with by a user. In one embodiment, the speed of the rotational user input is determined 1002 based on the number of rotational units identified by the rotational user input. More particularly, in another embodiment, the speed of the rotational user input is determined 1002 based on the number of rotational units and an amount of time over which such rotational inputs were received. The speed of the rotational user input can, for example, be considered to be the speed of a user movement or the speed of rotation of a rotational input device.

After the speed of the rotational user input has been determined 1002, a decision 1004 determines whether the speed of the rotational user input is slow. The speed of the rotational user input can be determined or estimated, directly or indirectly, in a variety of ways. In one embodiment, a threshold is used to distinguish between slow and fast speeds of the rotational user input. The precise rate of rotation that is deemed to be the threshold between slow and fast can vary with application. The threshold can be determined experimentally based upon the particular application for which the acceleration amount processing 1000 is utilized.

Once the decision 1004 determines that the speed of the rotational user input is slow, then the acceleration factor (AF) is set 1006 to zero (0). On the other hand, when the decision 1004 determines that the speed of the rotational user input is not slow (i.e., the speed is fast), then a decision 1008 determines whether an amount of time (Δt1) since the last time the acceleration was altered exceeds a first threshold (TH1). When the decision 1008 determines that the amount of time (Δt1) since the last acceleration update is longer than the first threshold amount (TH1), then the acceleration factor is modified 1010. In particular, in this embodiment, the modification 1010 causes the acceleration factor to be doubled.

Following the operation 1010, as well as following the operation 1006, an acceleration change time is stored 1012. The acceleration change time reflects the time that the acceleration factor was last updated. The acceleration change time is stored such that the decision 1008 understands the amount of time since the acceleration was last modified (i.e., Δt1). Following the operation 1012, as well as directly following the decision 1008 when the amount of time since the last acceleration update was made is less than the first threshold (TH1), the acceleration amount processing 1000 is complete and ends.

Hence, according to the acceleration amount processing 1000, when the speed of the rotational user input is deemed slow, the acceleration factor is reset to zero (0), which indicates that no acceleration effect is imposed. On the other hand, when the speed of the rotational user input indicates that the speed of such rotation is fast, then the acceleration effect being imposed is doubled. In effect, then, if the user interacts with the rotational input device such that the speed of rotation is slow, then no acceleration effect is provided. In such case, the user can scroll through a list with high resolution. On the other hand, when the user interacts with the rotational input device with a high speed of rotation, then the acceleration effect is step-wise increased (e.g., via doubling or other means). The acceleration effect provided by the invention enables a user to interact with a rotational input device in an efficient, user-friendly manner such that long or extensive lists can be scrolled through in a rapid manner.

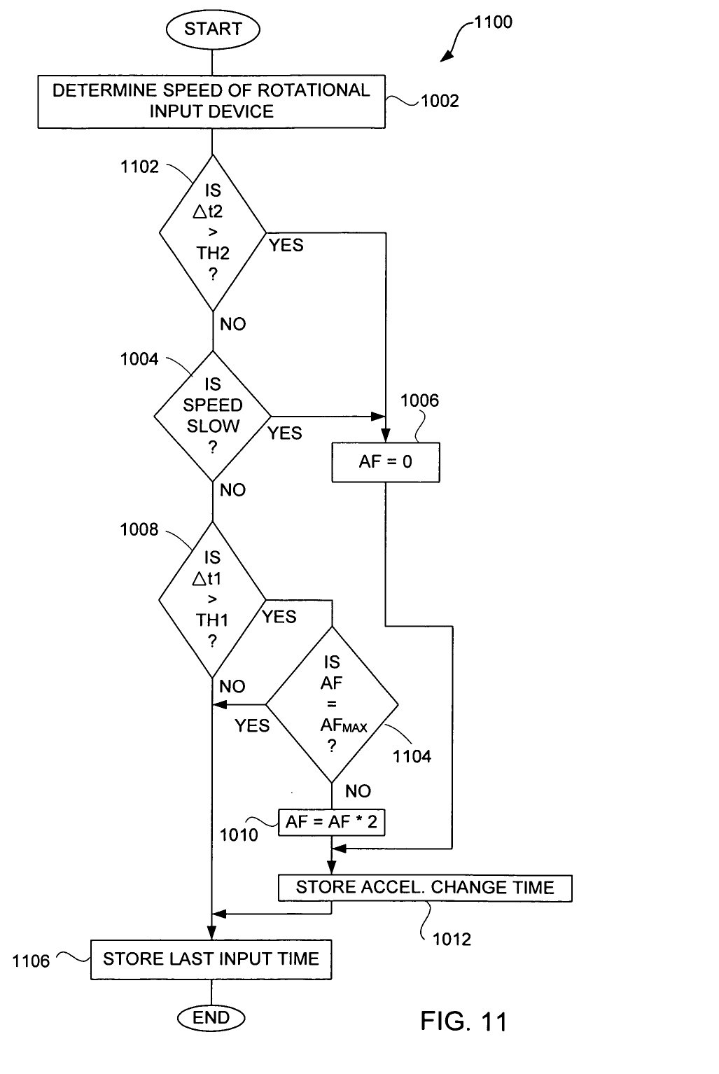

FIG. 11 is a flow diagram of acceleration amount processing 1100 according to another embodiment of the invention. The acceleration amount processing 1100 is generally similar to the acceleration amount processing 1000 illustrated in FIG. 10. However, the acceleration amount processing 1100 includes additional operations that can be optionally provided. More specifically, the acceleration amount processing 1100 can utilize a decision 1102 to determine whether a duration of time (Δt2) since the last rotational user input is greater than a second threshold (TH2). When the decision 1102 determines that the duration of time (Δt2) since the last rotational user input exceeds the second threshold (TH2), then the acceleration factor is reset 1006 to zero (0). Here, when the user has not provided a subsequent rotational user input for more than the duration of the second threshold (TH2), then the acceleration amount processing 1100 is reset to no acceleration because it assumes that the user is restarting a scrolling operation and thus would not want to continue with a previous accelerated rate of scrolling.

The rate at which the acceleration effect is doubled is restricted such that the doubling (i.e., operation 1010) can only occur at a rate below a maximum rate. The acceleration amount processing 1100 also includes a decision 1104 that determines whether the acceleration factor (AF) has reached a maximum acceleration factor (AF_{MAX}). The decision 1104 can be utilized to limit the maximum acceleration that can be imposed by the acceleration amount processing 1100. For example, the acceleration factor (AF) could be limited to a factor of sixteen (16), representing that with maximum acceleration scrolling would occur at a rate sixteen (16) times faster than non-accelerated scrolling.

Still further, the acceleration amount processing 1100 stores 1106 a last input time. The last input time (t2) represents the time the last rotational user input was received (or processed). Note that the duration of time (Δt2) can be determined by the difference between a current time associated with an incoming rotational user input and the last input time (t2).

As previously noted, the acceleration amount processing 1000 and 1100 is, for example, processing that can be performed to determine an acceleration factor. However, although not depicted in FIG. 10 or 11, when the length of the data set (e.g., list) is short, then the acceleration can be set to zero (i.e., no acceleration) and the acceleration amount processing 1000, 1100 can be bypassed. For example, in one embodiment, where the data set is a list, if the display screen can display only five (5) entries at a time, then the list can be deemed short if it does not include more than twenty (20) items. Consequently, according to another embodiment of the invention, the acceleration effect imposed by the invention can be dependent on the length of the data set (e.g., list).

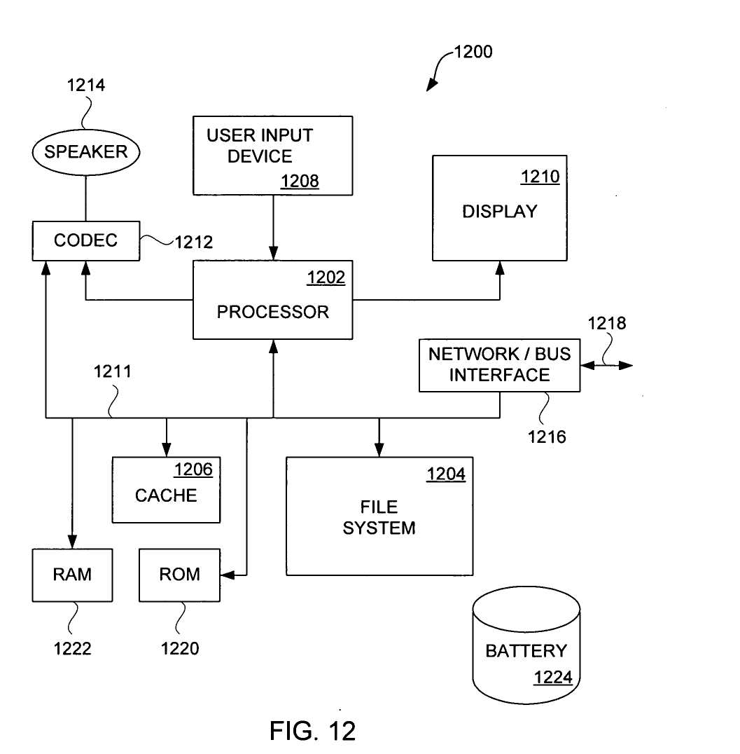

FIG. 12 is a block diagram of a media player 1200 suitable for use with the invention. The media player 1200 illustrates circuitry of a representative portable media device.

The media player 1200 includes a processor 1202 that pertains to a microprocessor or controller for controlling the overall operation of the media player 1200. The media player 1200 stores media data pertaining to media items in a file system 1204 and a cache 1206. The file system 1204 is, typically, semiconductor memory (e.g., Flash memory) or one or more storage disks. The file system 1204 typically provides high capacity storage capability for the media player 1200. However, since the access time to the file system 1204 can be relatively slow, the media player 1200 can also include the cache 1206. The cache 1206 is, for example, Random-Access Memory (RAM) provided by semiconductor memory. The relative access time to the cache 1206 is typically shorter than for the file system 1204. However, the cache 1206 does not have the large storage capacity of the file system 1204. Further, the file system 1204, when active, consumes more power than does the cache 1206. The power consumption is often a concern when the media player 1200 is a portable media player that is powered by a battery 1224. The media player 1200 also includes a RAM 1220 and a Read-Only Memory (ROM) 1222. The ROM 1222 can store programs, utilities or processes to be executed in a non-volatile manner. The RAM 1220 provides volatile data storage, such as for the cache 1206.

The media player 1200 also includes a user input device 1208 that allows a user of the media player 1200 to interact with the media player 1200. For example, the user input device 1208 can take a variety of forms, such as a button, keypad, dial, touch-sensitive surface, etc. Still further, the media player 1200 includes a display 1210 (screen display) that can be controlled by the processor 1202 to display information to the user. A data bus 1211 can facilitate data transfer between at least the file system 1204, the cache 1206, the processor 1202, and the CODEC 1212.

In one embodiment, the media player 1200 serves to store a plurality of media items (e.g., songs, videos, podcasts, etc.) in the file system 1204. When a user desires to have the media player play a particular media item, a list of available media items is displayed on the display 1210. Then, using the user input device 1208, a user can select one of the available media items. The processor 1202, upon receiving a selection of a particular media item, supplies the media data to one or more appropriate output devices. As an example, for audio output, the processor 302 can supply the media data (e.g., audio file) for the particular media item to a coder/decoder (CODEC) 1212. The CODEC 1212 can then produce analog output signals for a speaker 1214. The speaker 1214 can be a speaker internal to the media player 1200 or external to the media player 1200. For example, headphones or earphones that connect to the media player 1200 would be considered an external speaker.

The media player 1200 also includes a network/bus interface 1216 that couples to a data link 1218. The data link 1218 allows the media player 1200 to couple to another device (e.g., a host computer, a power source, or an accessory device). The data link 1218 can be provided over a wired connection or a wireless connection. In the case of a wireless connection, the network/bus interface 1216 can include a wireless transceiver. The data link 1218 can also provide power to the media player 1200 (e.g., to charge the battery 1224).

With the character scroll mode discussed above beyond a leading character or a leading significant character, the techniques discussed above can be used to traverse a list in a nested way. For example, a user could character scroll for a first character and then character scroll for a second character, whereby the two selected character could be used in combination to present the corresponding items in the list.

Although the above discussion discusses a character scroll mode, in one embodiment, numbers and symbols can be traversed (e.g., scrolled) in a similar manner. In one implementation, numbers or symbols can be treated as characters. As an example, all items beginning with number can be grouped into a number “character” and the character could, for example, be displayed as “123” or “#s” to inform the user that the number group can be selected.

A menu is one form of a list. A list is more generally a data set. A data set pertains to a set of data. As one example, the data set can be a list of items (e.g., a list of songs). As another example, the data set can be a media file (e.g., MP3 or other audio file, video file, or image file). In one embodiment, the data set can be considered an ordered data set because the data within the set is often ordered. For example, the songs in a list are arranged alphabetically. Beside an alphabetical ordered, various other ordering can be used. For example, a data set (e.g., list) can be ordered by a rating, a genre, an album, an artist, duration, date, etc.

“Media items,” as used herein, is digital data that pertains to at least one of audio, video, and images. Some examples of specific forms of media items include, but are not limited to, songs, albums, audiobooks, playlists, movies, music videos, photos, computer games, podcasts, audio and/or video presentations, news reports, and sports updates.

U.S. Patent Publication No. 2003/0076301 A1 is hereby incorporated by reference herein. U.S. Patent Publication No. 2003/0095096 A1 is hereby incorporated by reference herein. U.S. Patent Publication No. 2003/0055446 A1 is hereby incorporated by reference herein. U.S. Pat. No. 7,046,230 B2 is hereby incorporated by reference herein. U.S. Pat. No. 7,084,856 B2 is hereby incorporated by reference herein.

The various aspects, embodiments, implementations or features of the invention can be used separately or in any combination.

The invention can be implemented by software, hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, memory cards, magnetic tape, optical data storage devices, and carrier waves. The computer readable medium can also be distributed over network-coupled computer systems so that the computer readable code is stored and executed in a distributed fashion.

The advantages of the invention are numerous. Different embodiments or implementations may yield one or more of the following advantages. It should be noted that this is not an exhaustive list of advantages and there may be other advantages which are not described herein. One advantage of the invention is that a user is able to efficiently traverse through a displayed list of items. Another advantage of the invention is that a user is able to easily and rapidly traverse a lengthy list of items.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. In a portable electronic device having a user input device and a display, a method for assisted traversal of a list of items, said method comprising:
displaying, on the display of the portable electronic device, an initial set of media items from the list that have a current character as a significant character;
receiving, via the user input device, a user input pertaining to a traversal action through the list;
determining whether to traverse the list in a character mode; and
displaying, on the display, a next character when the list is being traversed in the character mode.

2. A method as recited in claim 1, wherein said method further comprises:
displaying, on the display, an initial set of media items from the list that have the next character as the significant character.

3. A method as recited in claim 2, wherein said displaying of the next character is displayed over a portion of the initial set of media items from the list that have the next character as the significant character.

4. A method as recited 3, wherein said displaying of the next character is displayed within a partially transparent overlay.

5. A method as recited in claim 1, wherein the significant character is a leading significant character.

6. A method as recited 1, wherein said determining of whether to traverse the list in a character mode is based on characteristics of the user input.

7. A method as recited in claim 6, wherein the user input corresponds to a user movement with respect to the user input device, and wherein the characteristics of the user movement include a quantification of the user movement.

8. A method as recited in claim 7,
wherein said method further comprises:
displaying, on the display, an initial set of media items from the list that have the next character as the significant character, and
wherein said displaying of the next character is displayed over a portion of the initial set of media items from the list that have the next character as the significant character.

9. A method as recited 8, wherein said displaying of the next character is displayed within a partially transparent overlay.

10. A method as recited in claim 9, wherein the significant character is a leading significant character.

11. A method as recited in claim 1, wherein said method assists a user in scrolling the list of items, and wherein the traversal action is a scroll action.

12. A method as recited in claim 1, wherein the items in the list are media items.

13. A method as recited in claim 12, wherein the media items are ordered alphabetically in the list.

14. A method for selecting an item in a list of items, said method comprising:
receiving a user input having characteristics; and
determining whether to utilize a first list traverse mode or a second list traverse mode based on the characteristics of the user input;
when in the first list traverse mode,
determining a next set of the items in the list to be displayed; and
displaying the determined next set of items;
when in the second list traverse mode,
determining a next initial character within the list;
determining an initial set of items from the list that have the next initial character as their initial significant character; and
displaying the determined initial set of items from the list.

15. A method as recited in claim 14, wherein the user input corresponds to a user movement.

16. A method as recited in claim 15, wherein the user movement is a rotational movement.

17. A method as recited in claim 15, wherein the user movement is a sliding finger action across a touch-sensitive surface.

18. A method as recited in claim 14, wherein the list is an alphabetically order list.

19. A method as recited in claim 14, wherein, in the second list traverse mode, said method further comprises:
displaying a representation of the next initial character concurrently with said displaying of the determined initial set of items from the list.

20. A method as recited in claim 14, wherein, in the second list traverse mode, said method further comprises:
determining whether the next initial character is an excluded character; and
switching to the first list traverse mode until a next initial character is not an excluded character.

21. A method as recited in claim 14, wherein, in the second list traverse mode, said method further comprises:
determining whether the next initial character is an non-English character; and
mapping the next initial character to an English character.

22. A computer readable medium including at least computer program code for assisting a user of an electronic device in selecting an item in a list of items, said method comprising:
computer program code for receiving a user input having characteristics; and
computer program code for determining whether to utilize a first list traverse mode or a second list traverse mode based on the characteristics of the user input.

23. A computer readable medium as recited in claim 22, wherein said computer readable medium further comprises:
computer program code for determining a next set of the items in the list to be displayed when the first list traverse mode is utilized;
computer program code for displaying the determined next set of items when the first list traverse mode is utilized;
computer program code for determining a next initial character within the list when the second list traverse mode is utilized;
computer program code for determining an initial set of items from the list that have the next initial character as their initial significant character when the second list traverse mode is utilized; and
computer program code for displaying the determined initial set of items from the list when the second list traverse mode is utilized.

24. A computer readable medium as recited in claim 23, wherein said computer readable medium further comprises:
computer program code for displaying a representation of the next initial character.

25. A computer readable medium as recited 24, wherein the next character is displayed within a partially transparent overlay provided over the determined initial set of items from the list also being displayed.

26. A computer readable medium as recited in claim 22, wherein the electronic device is a portable media player having a display device and a rotational input device.

27. A computer readable medium as recited in claim 26, wherein said computer readable medium further comprises:
computer program code for receiving a number of units associated with a rotational user input, the rotational user input being provided by a user through interaction with the rotational input device;
computer program code for determining an acceleration factor pertaining to the rotational user input;
computer program code for determining a next set of the items in the list to be displayed based on the number of units received and the acceleration factor when the first list traverse mode is utilized; and
computer program code for displaying the determined next set of items when the first list traverse mode is utilized.

28. A computer readable medium as recited in claim 27, wherein the rotational input device is a touch pad.

29. A computer readable medium as recited in claim 27, wherein the acceleration factor is dependent upon a rate of speed for the rotational user input.

30. A computer readable medium as recited in claim 27, wherein the acceleration factor can successively increase to provided successively greater levels of acceleration.

31. A media playback device, comprising:
a display device;
a user input device;
at least one memory device capable of storing a plurality of media items and computer program code for displaying and navigating the plurality of media items; and
a processing device operatively connected to said display device, said user input device and said at least one memory device, said processing device capable of executing the computer program code for displaying and navigating the plurality of media items,
wherein the computer program code for displaying and navigating the plurality of media items includes at least:
computer program code for receiving a user input having characteristics; and
computer program code for determining whether to utilize a first list traverse mode or a second list traverse mode based on at least one characteristic of the user input.

32. A media playback device as recited in claim 31, wherein said input device is a rotational input device capable of receiving a rotational user input.

33. A media playback device as recited in claim 31, wherein the at least one characteristic of the user input is at least one of speed, distance or acceleration.

34. A media playback device as recited in claim 31, wherein the second list traverse mode is a character scroll mode.

35. A media playback device as recited in claim 31, wherein said media playback device is a battery-powered, handheld media playback device.

36. A media playback device as recited in claim 35, wherein the media player is an MP3 player, and wherein the media items are audio files for songs.
